(19) United States
(12) Patent Application Publication
(10) Pub. No.: US 2025/0339953 A1
(43) Pub. Date: Nov. 6, 2025

(54) VACUUM MOUNT FOR INSPECTION AND MAINTENANCE ROBOT

(71) Applicant: Zetec, Inc., Snoqualmie, WA (US)

(72) Inventors: Tom O’Dell, Maple Valley, WA (US); Dave Rollinson, Pittsburgh, PA (US); Evan Lloyd, Fall City, WA (US)

(21) Appl. No.: 19/194,624

(22) Filed: Apr. 30, 2025

Related U.S. Application Data
(60) Provisional application No. 63/641,133, filed on May 1, 2024.

(51) Int. Cl. B25J 9/00; B25J 11/00; B25J 15/04; B25J 15/06

(52) U.S. Cl. CPC B25J 9/0009; B25J 11/008; B25J 15/0441; B25J 15/0683

(57) ABSTRACT

A vacuum mount for an inspection and maintenance robot, includes a vacuum mount housing configured for releasable coupling to the inspection and maintenance robot, at least one vacuum pump provided in the vacuum mount housing; and at least one vacuum foot articulatably coupled to the vacuum mount housing. The at least one vacuum foot receives a source of negative pressure from the at least one vacuum pump. The vacuum mount housing includes power and communications independently from the inspection and maintenance robot so as to be capable of generating the source of negative pressure when not coupled to the inspection and maintenance robot.

### CROSS-REFERENCE TO RELATED APPLICATION

This application claims priority under 35 U.S.C. § 119, based on U.S. Provisional Patent Application No. 63/641,133 filed May 1, 2024, titled “Vacuum Mount for Inspection and Maintenance Robot,” the disclosure of which is hereby incorporated by reference.

### BACKGROUND

Robotic systems have been developed for remotely performing testing, repair, and maintenance operations within various hazardous or difficult to access environments, such as nuclear steam generators, maritime vessels (e.g., ship hulls, holds, etc.), holding tanks (e.g., underground storage or fuel tanks, aviation fuel tanks, etc.), water towers, etc. Known inspection robots currently fall into two configurations: arm style robots, mounted onto the entry port, and walking robots which are capable of moving within the testing environment and may utilize various tools or other end effectors, such as an eddy current inspection probe, into proximity with the component to be inspected.

### BRIEF DESCRIPTION OF THE DRAWINGS

FIG. 1 is an isometric view of an inspection and maintenance robot consistent with implementations described herein;

FIGS. 2A-2D depict top plan, cross-sectional (through the line A-A in FIG. 2A), top exploded isometric, and bottom exploded isometric views, respectively, of an exemplary embodiment of a coupling device accordingly to implementations described herein;

FIGS. 3A-3D are side plan, top cross-section view (along line B-B in FIG. 3A), top exploded isometric, and bottom exploded isometric views, respectively, of a vacuum mount consistent with implementations described herein;

FIG. 3E is an isometric view of a vacuum mount with vacuum feet in a fully articulated configuration consistent with implementations described herein;

FIGS. 4A and 4B are top and bottom exploded isometric views, respectively, of a vacuum foot consistent with implementations described herein;

FIG. 5A is an isometric views of an end effector device consistent with implementations described herein;

FIG. 5B is an isometric views of an end effector device mounted on a vacuum mount consistent with implementations described herein;

FIGS. 6A-6D are side plan, top cross-section view (along line C-C in FIG. 6A), top exploded isometric, bottom exploded isometric views, respectively, of a vacuum mount consistent with a second implementation described herein;

FIG. 6E is a side cross-section view of the vacuum mount of FIGS. 6A-6D taken along the line D-D in FIG. 6B;

FIG. 6F is an isometric view of the vacuum mount of FIGS. 6A-6D with vacuum feet in a fully articulated configuration consistent with implementations described herein;

FIGS. 7A-7D are a top exploded isometric view, a bottom exploded isometric view, a top view, and a cross-sectional view taken along the line E-E in FIG. 7C, respectively, of the vacuum foot of FIGS. 6A-6F, consistent with implementations described herein;

FIG. 8A is a flow diagram depicting an exemplary process for implementing inspection and maintenance robot within a test environment in a manner consistent with implementations described herein; and

FIG. 8B-8C depict a flow diagram depicting another exemplary process for implementing inspection and maintenance robot within a test environment consistent with implementations described herein.

### DETAILED DESCRIPTION OF PREFERRED EMBODIMENTS

Those skilled in the art will recognize other detailed designs and methods that can be developed employing the teachings of the present invention. The examples provided here are illustrative and do not limit the scope of the invention, which is defined by the attached claims. The following detailed description refers to the accompanying drawings. The same reference numbers in different drawings may identify the same or similar elements.

Consistent with embodiments described herein, an independently controllable vacuum mount is provided for use in conjunction with an inspection and maintenance robot system. The vacuum mount includes an interface for engaging with a robotic arm. The vacuum mount further includes a self-contained vacuum pump for providing vacuum pressure to a plurality of articulated feet mounted thereto. As described below, the inspection and maintenance robot system may selectively couple to one or more vacuum mounts to facilitate testing or maintenance operations in the testing environment.

For example, in some implementations, the inspection and maintenance robot system may “bipod walk” within the environment by coupling to two vacuum mounts and selectively applying and removing vacuum pressure to each vacuum mount. In other implementations, the inspection and maintenance robot system may utilize a fixed mount at a point of entry to the environment and a single vacuum mount on the robot's distal end. Upon reaching location within the environment proximate to a test location, the robot may disengage from the fixed mount and engage a suitable tool. In still other implementations, inspection and maintenance robot system may utilize a third vacuum mount to facilitate independent placement (i.e., “parking”) of a vacuum mount within the testing environment to serve as a holding platform for inspection or maintenance tools while the robot navigates to a selected location.

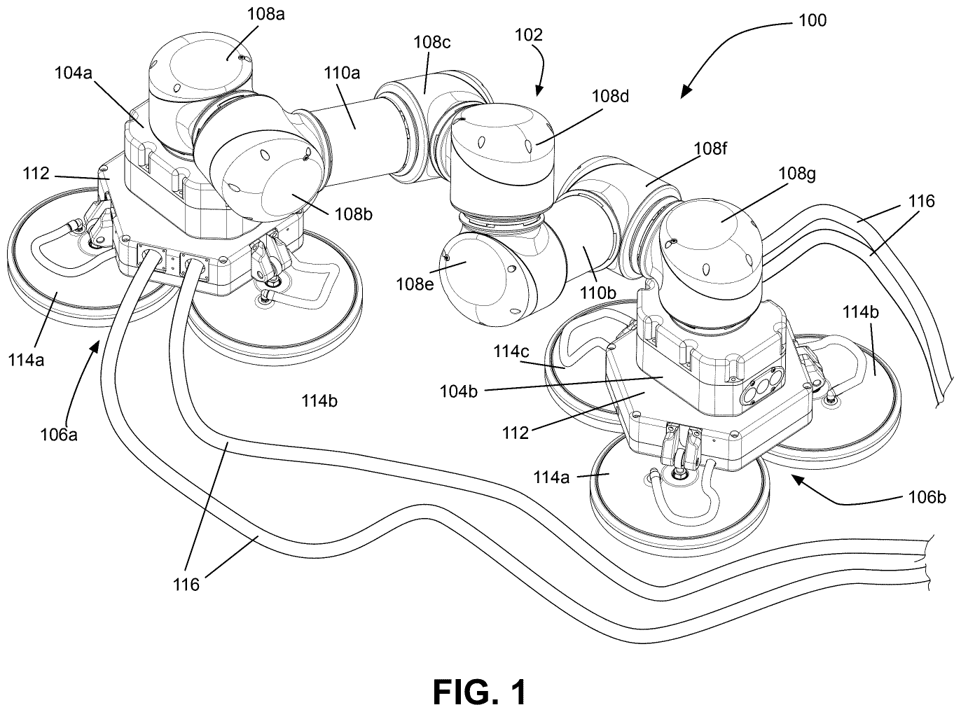

FIG. 1 is an isometric view of an inspection and maintenance robot 100 consistent with implementations described herein. As shown, inspection and maintenance robot 100 includes a robotic arm assembly 102, coupling devices 104a and 104b (individually referred to as coupling device 104 and collectively referred to as coupling devices 104), and vacuum mounts 106a and 106b (individually referred to as vacuum mount 106 and collectively referred to as vacuum mounts 106).

As shown, robotic arm assembly 102 comprises a plurality of articulatable segments 108a-108g (individually referred to as articulatable segment 108 and collectively referred to as articulatable segments 108), and a plurality of interconnecting segments 110a and 110b (individually referred to as interconnecting segment 110 and collectively referred to as interconnecting segments 110). Each articulatable segment 108 includes one or more motors or actuators for enabling relative rotation therebetween. Such an arrangement allows for multiple degrees of freedom with high precision. Although not shown in FIG. 1 for simplicity, consistent with implementations described herein, components of robotic arm assembly 102 may be operatively connected to power, network, and/or pneumatic wiring or cabling, which may, in turn, be coupled to one or more remote control devices, in some implementations, components 108/110 of robotic arm assembly 102 may include a generally tubular configuration that allows the cabling or wiring to be routed through robotic arm assembly 102, rather than externally thereto.

Each coupling device 104 facilitate releasable and interchangeable attachment to a mount (e.g., vacuum mount 106) or an end effector device (e.g., tool), as described in detail below. As shown, coupling devices 104 are coupled to distal and proximal articulatable segments 108a and 108g and may be articulable relative to the segments 108 to which they are coupled.

Similar to articulatable segments 108, coupling devices 104 are also operatively connected to power, network, and/or pneumatic wiring or cabling via one or more electrical, mechanical, and pneumatic interfaces. Exemplary network/electrical interfaces may include ethernet cabling or the like, which may also provide power via, for example, power of ethernet (POE). Coupling devices 104 may include one or more processors or microcontrollers for facilitating connection to and operation of the various components of inspection and maintenance robot 100, such as end effector devices or device mounts (e.g., vacuum mounts 106).

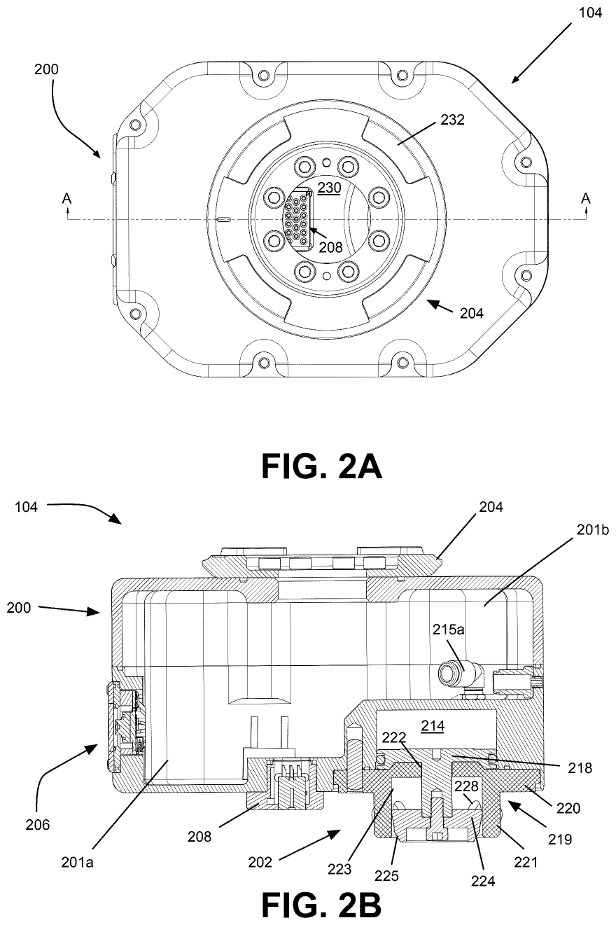

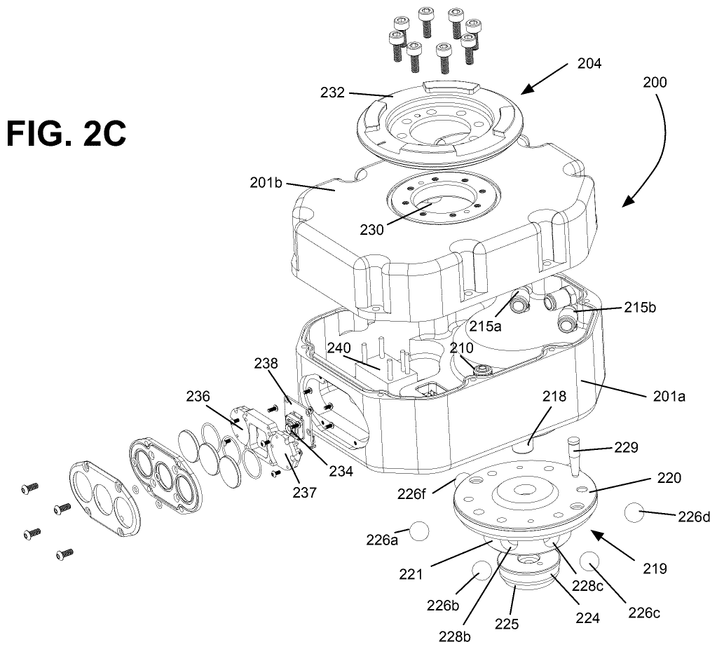

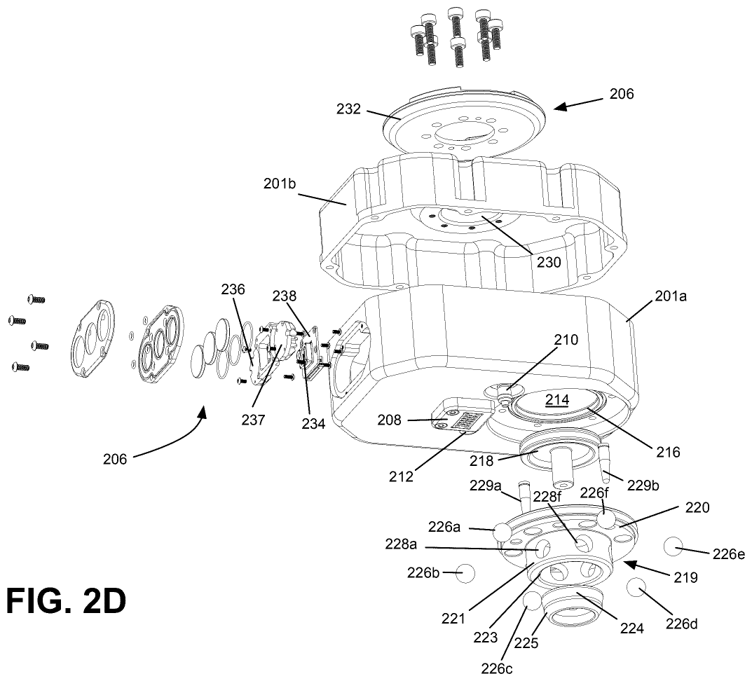

FIGS. 2A-2D depict top plan, cross-sectional (through the line A-A in FIG. 2A), top exploded isometric, and bottom exploded isometric views, respectively, of an exemplary embodiment of a coupling device 104 accordingly to implementations described herein. As shown, coupling device 104 includes a housing 200, an end effector connector assembly 202 and a robotic arm connection assembly 204. In some implementations, coupling device 104 may further include an imaging assembly 206, an end effector electrical interface 208, an end effector pneumatic interface 210, and a proximity sensor 212.

As shown in FIGS. 2B and 2C, housing 200 of coupling device 104 includes a lower housing 201a and a mating upper housing 201b secured to each other via any suitable means, such as bolts, clips, etc. In one implementation, lower housing 201a houses end effector connector assembly 202, imaging assembly 206, end effector electrical interface 208, end effector pneumatic interface 210, and proximity sensor 212, although relative configurations thereof are exemplary and other configurations may be used.

End effector connector assembly 202 includes a mechanism for securely and releasably coupling an end effector or mount, such as a vacuum mount 106, to coupling device 104. In one implementation, as shown in FIGS. 2B-2D, lower housing 201a includes a connector cavity 214 having an opening 216 therein for interfacing with end effector connector assembly 202. Cavity 214 is coupled to pneumatic sources of positive and negative pressure via pneumatic interfaces 215a and 215b and is sized to receive a connector actuator piston 218 via opening 216. Connector actuator piston 218 is sealed relative to cavity 214 by O-ring or seal 220.

End effector connector assembly 202 further includes a connecting interface shaft 219 secured to lower housing 201a and concentrically aligned with cavity 214 and connector actuator piston 218, such that a leading end of connector actuator piston 218 projects within connecting interface shaft 219. As shown in FIGS. 2B-2D, connecting interface shaft 219 includes generally disc-shaped mounting flange 220 at one end for securing to lower housing 201a and a shaft portion 221 projecting outwardly from mounting flange 220. Connecting interface shaft 219 includes a central aperture having a first portion 222 with a first internal diameter at the mounting flange 220 and a second portion 223 having a second internal diameter at shaft portion 221. As shown, the first internal diameter at first portion 222 is sized to receive the leading end of actuator piston 218. The second internal diameter at the second portion 223 is sized to receive a lock actuator member 224 secured to the leading end of actuator piston 218.

As shown in FIGS. 2B, lock actuator member 224 includes an angled outside profile 225 configured to engage a plurality of locking balls 226a-226f (individually referred to as locking ball 226 and collectively referred to as locking balls 226) mounted within shaft portion 222 of connecting interface shaft 220 upon the application of positive pressure within cavity 214. In some implementations, locking balls 226 may be spaced radially about a central axis of connecting interface shaft 220. Furthermore, although six spaced locking balls 226 are illustrated, more or fewer locking balls 226 may be used depending on the implementation. To accommodate locking balls 226, shaft portion 221 includes a plurality of radial apertures 228a-228g (individually referred to as aperture 228 and collectively referred to as apertures 228). Apertures 228 are sized to receive locking balls 226 therein. In particular, apertures 228 are configured to allow locking balls 226 to travel between locked and unlocked positions within shaft portion 222 to accommodate secure coupling to an end effector or mount, as described below.

As shown in FIGS. 2C and 2D, end effector connector assembly 202 may include a plurality of locating features 229a and 229b which project outwardly from lower housing 201a and that are configured to mate with corresponding features in an end effector or mount. Such locating features ensure that the end effector or mount is installed in a proper orientation with respect to coupling device 104.

Upon application of positive pressure to cavity 214, actuator piston 218 is forced downward, which causes the angled outer profile 225 of lock actuator member 224 to engage locking balls 226, urging them radially outward and into locking engagement with a corresponding mounting structure in an end effector or mount, as described below. In contrast, upon application of negative pressure to cavity 214, actuator piston 218 is retracted within cavity 214, which causes the angled outer profile 225 of lock actuator member 224 to disengage from locking balls 226, thereby allowing locking balls 226 to move radially inwardly, thus allowing the removal of connecting interface shaft 220 from the end effector or mount.

In one implementation, as shown in FIG. 2C, robotic arm connection assembly 204 is mounted within upper housing 201b and includes a housing aperture 230, and a coupling ring 232. Housing aperture 230 provides access to an interior of housing 200 for wiring, cabling, tubing or the like routed through robot arm assembly 102, as described above. Coupling ring 232 provides an interface for engaging corresponding features in robot arm assembly 102, such as clips, magnets, etc. which facilitate secure and persistent coupling of coupling device 104 to robotic arm assembly 102.

Imaging assembly 206 includes camera element 234, a plurality of lighting elements 236 and 237, a printed circuit board (PCB) 238, and a lighting driver unit 240 among other complementary features. In some implementations, features of imaging assembly 206 may facilitate remote viewing or autonomous navigation (e.g., mapping, etc.) of a testing environment.

End effector electrical interface 208, sometimes referred to as a hot shoe interface, may allow for a releasable electrical connection between coupling device 104 and an end effector device, such as a non-destructive testing (NDT) tool head. Similarly, end effector pneumatic interface 210 may allow for a releasable pneumatic connection between coupling device 104 and an end effector device, such as an NDT tool head. Proximity sensor 212 may be positioned within a lower surface of lower housing 201a and may facilitate proper connection between coupling device 104 and an end effector or mount, such as an NDT tool head or a vacuum mount 106. More specifically, proximity sensor 212 may allow coupling device 104 (or remote control devices connected to coupling device 104) to identify a position of an end effector or mount and may initiate the locking process.

Returning to FIG. 1, each of vacuum mounts 106 include a housing 112 and a plurality of vacuum feet 114a to 114c (individually referred to as a vacuum foot 114 and collectively referred to as vacuum feet 114). Although vacuum mount 106 described herein includes three vacuum feet 114, that number is exemplary, and more or fewer vacuum feet may be used based on a desired configuration. Further, as shown, each vacuum mount 106 may be coupled to remote power/network cabling 116 that allows each vacuum mount 106 to operate independently from or in conjunction with robotic arm assembly 102. Consistent with implementations described herein, each vacuum foot 114 may be capable of vacuum securement to a planar surface, such as a dividing plate in a nuclear steam generator, independently from and in coordination with robotic arm assembly 102.

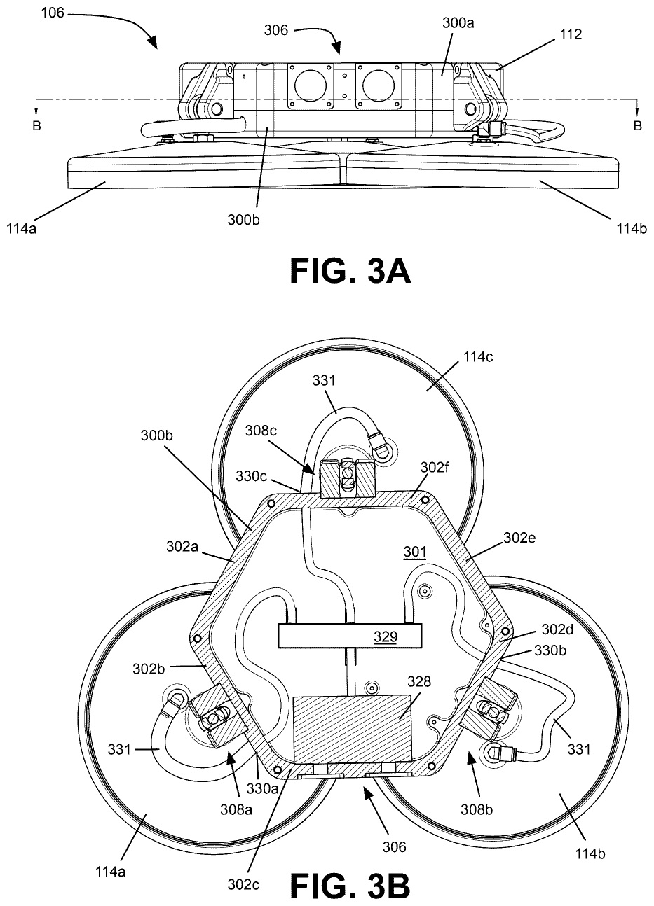

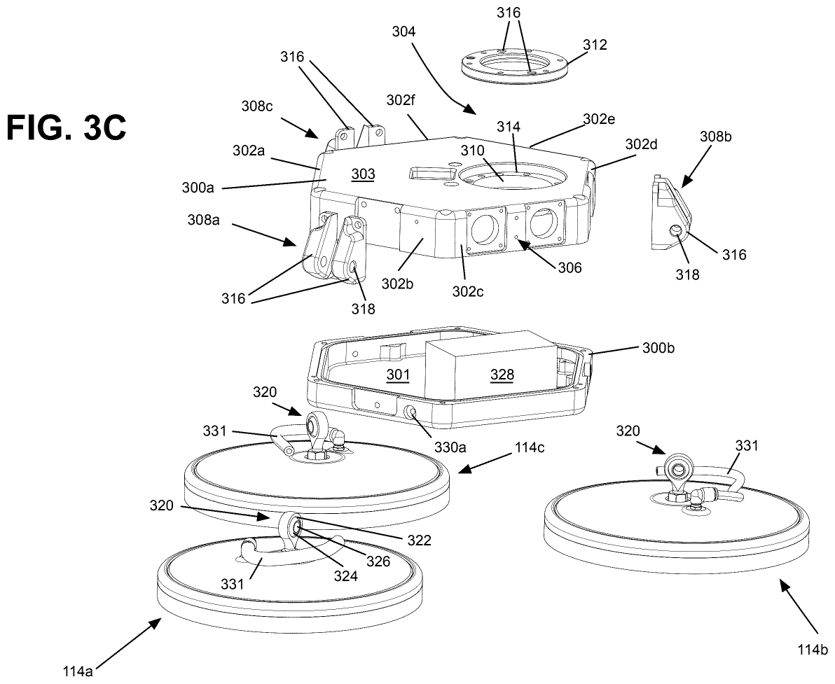

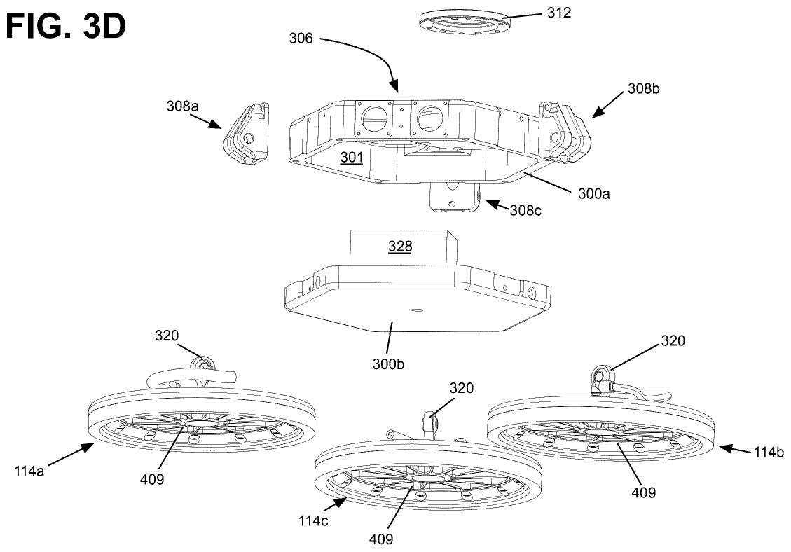

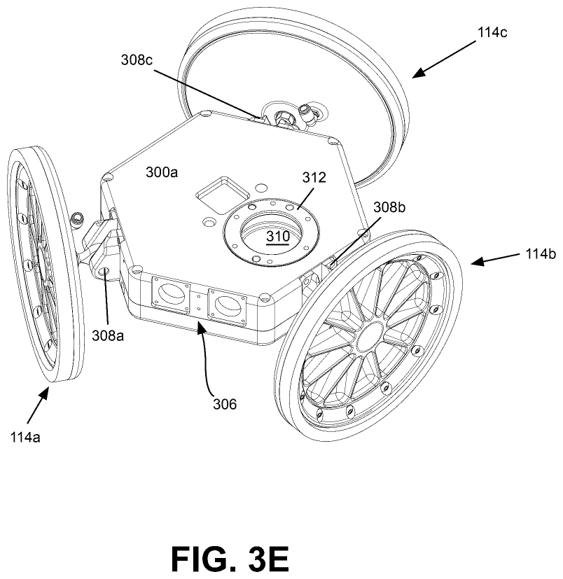

FIGS. 3A-3D are side plan, top cross-section view (along line B-B in FIG. 3A), top isometric, bottom isometric, top exploded isometric, and bottom exploded isometric views, respectively, of a vacuum mount 106 consistent with implementations described herein. FIG. 3E is an isometric view of vacuum mount 106 depicting feet 114 in a rotated, or pre-deployment configuration. As shown, vacuum mount housing 112 includes an upper housing 300a and a lower housing 300b coupled together via any suitable mechanism, such as bolts, latches, clips, etc. to form a housing chamber 301 therein. Consistent with implementations described herein, upper and lower housings 300a/300b include a generally hexagonal configuration having size identical side walls 302a-302f. As described below, such a configuration allows for efficient packaging of vacuum mount 106 that enables vacuum mount 106 to be inserted into a testing environment via an access port.

Upper housing 300a includes a coupling device interface assembly 304 formed in a top surface 303 thereof, a remote cabling/wiring interface 306 positioned within a side wall 302, and a plurality of mounting hinges 308a to 308c (individually referred to as mounting hinge 308 and collectively referred to as mounting hinges 308) also mounted to respective side walls 302, as further described below.

As shown in FIGS. 3C and 3D, coupling device interface assembly 304 comprises a circular cavity 310 and a lock engagement ring 312. Circular cavity 310 is formed in top surface 303 includes a diameter and depth sufficient to accommodate receipt of connecting interface shaft 220 and locking balls 226. Circular cavity 310 further includes a shoulder portion 314 for receiving lock engagement ring 312 thereon. Lock engagement ring 312 is secured to shoulder portion 314 and includes a generally ring-like configuration having an outside diameter similar to shoulder portion 314 and an inside diameter substantially identical to the outside diameter of shaft portion 221, yet smaller than the maximum outside diameter of locking balls 226, when actuated into the locked state, as described above. As shown, lock engagement ring 312 includes locating apertures 316 therein that correspond in position and size to locating features 229 in end effector connector assembly 202 to ensure accurate positioning of coupling device 104 relative to vacuum mount 106.

Remote cabling/wiring interface 306 provides a dedicated remote control interface for each vacuum mount 106 and may include ports or receptacles for various communications/power features, such as electricity, network cabling, etc. As shown in FIG. 1, wiring/cabling 116 is provided to remote cabling/wiring interface 306 in each vacuum mount 106. By providing a persistent independent source of power and control, vacuum mounts 106 and able to operate independently from robot arm assembly 102, allowing the vacuum mounts 106 to be “parked” at locations within the testing environment, when the robot is coupled to a testing tool or other end effector device.

Mounting hinges 308 provide an articulatable connection point for each vacuum foot 114. As shown, each mounting hinge 308 includes a pair of spaced apart hinge members 316 having a curved configuration with a transverse aperture 318 extending through each hinge member's widest portion and sized to receive a hinge pin (not shown). Spaced apart members 316 are spaced to receive a mounting post 320 therebetween.

As shown, mounting post 320 is secured to an upper surface of each vacuum foot 114 and projects upwardly therefrom. In one implementation, mounting post 320 includes an aperture 322 at its upper end sized to receive hinge pin (not shown). In some implementations, as shown, aperture 322 may be sized to receive a bushing or sleeve 324, which, in turn, includes an aperture 326 for receiving hinge pin 318 therethrough. Upon assembly of vacuum mount 106, mounting post 320 (with bushing/sleeve 324 installed) is positioned between spaced apart members 316 and a hinge pin is provided through apertures 322/326. The hinge pin may be secured in any suitable manner (e.g., retaining pin, bolt, friction cap, etc.), although such feature is not depicted in the figures. Providing vacuum feet 114 coupled to housing 112 via hinges 308 allows for vacuum feet 114 to be rotate upwardly during positioning, thereby reducing the diameter or size of any access port needed to accommodate vacuum mount 106, as shown in FIG. 3E. In other implementations, articulation of feet 114 via hinges 308 may facilitate securing of feet 114 to curved or angled surfaces relative to vacuum mount housing 112.

As shown in FIGS. 3C and 3D, vacuum mount housing 112 further includes a vacuum pump 328 and corresponding manifold 329 in housing chamber 301 to provide an independent source of vacuum to vacuum feet 114. Consistent with implementations described herein, vacuum pump 328 may be coupled to a remote source of power/control via remote cabling/wiring interface 306. Although not depicted in the figures, in some implementations, vacuum mount 106 may be provided with a second vacuum pump that operates in conjunction with vacuum pump 328 to provide failsafe performance in the event of a malfunction of vacuum pump 328.

Vacuum mount housing 112 includes vacuum ports 330a to 330c (individually referred to as a vacuum port 330 and collectively referred to as vacuum ports 330) provided proximate to each hinge 308/vacuum foot 114. Consistent with implementations described herein, manifold 329 may distribute vacuum pressure from vacuum pump 328 to vacuum feet 114 via vacuum ports 330. In some implementations, manifold 329 may be integrated into mount housing 112, such as within side walls 302 in lower housing 300b.

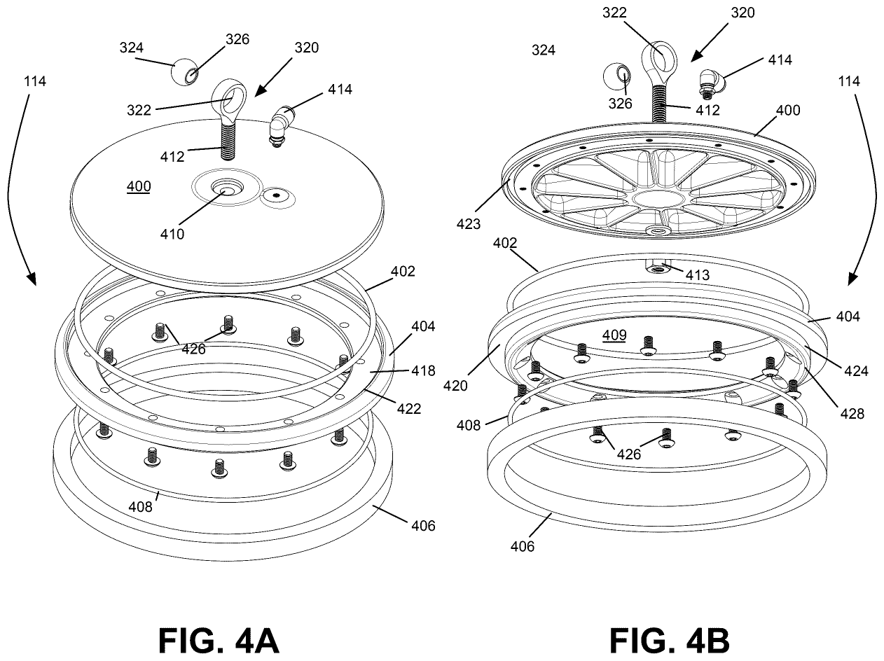

FIGS. 4A and 4B are top and bottom exploded isometric views, respectively, of a vacuum foot 114 consistent with implementations described herein. Consistent with one exemplary implementation, each vacuum foot 114 comprises a foot housing 400; a first sealing ring 402, a support ring 404, a compressible sealing ring 406; a compression limit ring 408, and a vacuum chamber 409.

Foot housing 400 includes a generally disc-shaped member configured to receive a distal end of mounting post 320. For example, foot housing 400 may include a central aperture 410 in an upper surface thereof for receiving a threaded distal end 412 of mounting post 320. In one implementation, as shown in FIGS. 4A-4B, threaded distal end 412 of mounting post 320 may be secured within central aperture 410 via a nut 413, although in other implementations, central aperture 410 may be threaded to securely engage mounting post 320 without the need for nut 412. Foot housing 400 further includes an air access port 414 configured to connect to a respective vacuum port 330 in vacuum mount housing 112. In some implementations, air access port 414 may include an air fitting, such as a quick connect fitting, to facilitate efficient coupling to vacuum port 330 via an air hose or tube 331.

First sealing ring 402 is provided concentrically distally on a perimeter of foot housing 400 between foot housing 400 and support ring 404 to provide an airtight engagement between support ring 404 and foot housing 400. First sealing ring 402 may be formed of a resilient material, such as a rubber or foam material.

Support ring 404 is a generally ring-shaped component having a top side 418, a bottom side 420, an outer sidewall 422, and an inner sidewall 424. Top side 418 of support ring 404 is configured to engage first sealing ring 402 and foot housing 400 and bottom side 420 of support ring 404 is configured to engage compressible sealing ring 406, as described below. Outer sidewall 422 projects upwardly from top side 418 and includes a diameter substantially identical to a groove 423 formed within a lower surface of foot housing 400, such that outer sidewall 422 is received within groove 423 in foot housing 400. Support ring 404 is mounted to an underside of foot housing 400 about its perimeter with first sealing ring 402 disposed therebetween. In one implementation, support ring 404 is mounted to foot housing 400 via a plurality of screws 426, so as to clampingly engage first sealing ring 402 in an airtight manner. In other implementations, support ring 404 may be secured to foot housing 300 in other manners, such as clamps, clips, an adhesive, etc.

Inner sidewall 424 projects downwardly from bottom side 420 of support ring 404 and includes an outside diameter substantially identical to an inside diameter of compressible sealing ring 406, such that, during assembly, compressible sealing ring 406 is received within inner sidewall 424 and positioned on bottom side 420 of support ring 404. The combination of foot housing 400, support ring 404, and compressible sealing ring 406 forms vacuum chamber 409 between a bottom surface of foot housing 400 and a surface of the environment in which robot 100 is placed.

Compressible sealing ring 406 may be formed of a compressible material, such as a foam material (e.g., a closed cell foam) configured to compress when a vacuum is formed within vacuum cavity 409. Inner sidewall 424 may further include a bottom surface 428 spaced from bottom side 420 of support ring 404 by a distance less than a thickness of compressible sealing ring 406. In one implementation, bottom surface 428 is configured to receive and engage compression limit ring 408 thereon. Compression limit ring 408 may be formed of a rigid or semi-rigid polymer, such as polyoxymethylene, or the like, and may act as a maximum compression limit on compressible sealing ring 406, when placed under vacuum pressure within vacuum cavity 409.

In one implementation, each of compressible sealing ring 406 and compression limit ring 408 may be secured to support ring 404 via an adhesive or similar mechanism. In other implementations, compressible sealing ring 406 and compression limit ring 408 may be secured to support ring 404 in other manners, such as via clips, screws, rivets, etc.

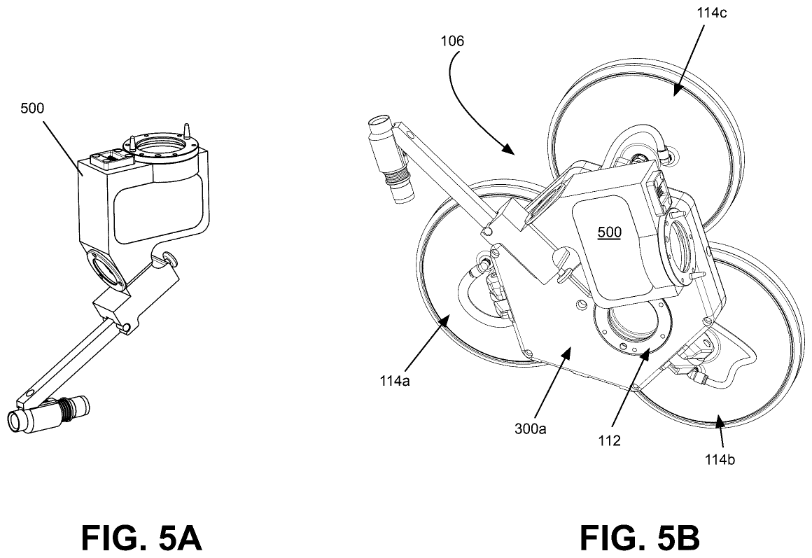

Consistent with implementations described herein, vacuum mounts 106 may be configured to engage or support an end effector device, such as inspection tool 500 depicted in FIG. 5A, when each of the particular vacuum mount 106 and the end effector device are not in use by (i.e., not actively coupled to) inspection and maintenance robot 100. Devices positioned in the test environment, but not actively coupled to inspection and maintenance robot 100 may be referred to as “parked.” Given their independent connections to power and communications, any number of vacuum mounts 106 may be parked in a test environment for use in supporting various end effector devices in desired locations or for providing efficient movement therebetween by inspection and maintenance robot 100 within the testing environment.

In one implementation, each of vacuum mount 106 and inspection tool 500 may be provided with mating mechanical clip structures that facilitate mounting of inspection tool 500 onto a parked vacuum mount 106. FIG. 5B illustrates one exemplary implementation of inspection tool 500 mounted onto vacuum mount 106. In alternative implementations, other mechanisms may be used to secure a parked end effector device to a parked vacuum mount 106, such as a magnetic coupling, a hook-and-loop style releasable interface, etc.

Once inspection and maintenance robot 100 is positioned at a desired location within the testing environment, using, for example, two different vacuum mounts 106, inspection and maintenance robot 100 may park one of the vacuum mounts 106 that was used to position robot 100 and may then retrieve inspection tool 500 from its parked location on the previously unused vacuum mount 106. In this manner, end effector devices may be efficiently placed in proximity to inspection and maintenance robot 100 for retrieval and use and may then be re-parked when inspection and maintenance robot 100 needs to reposition itself within the testing environment.

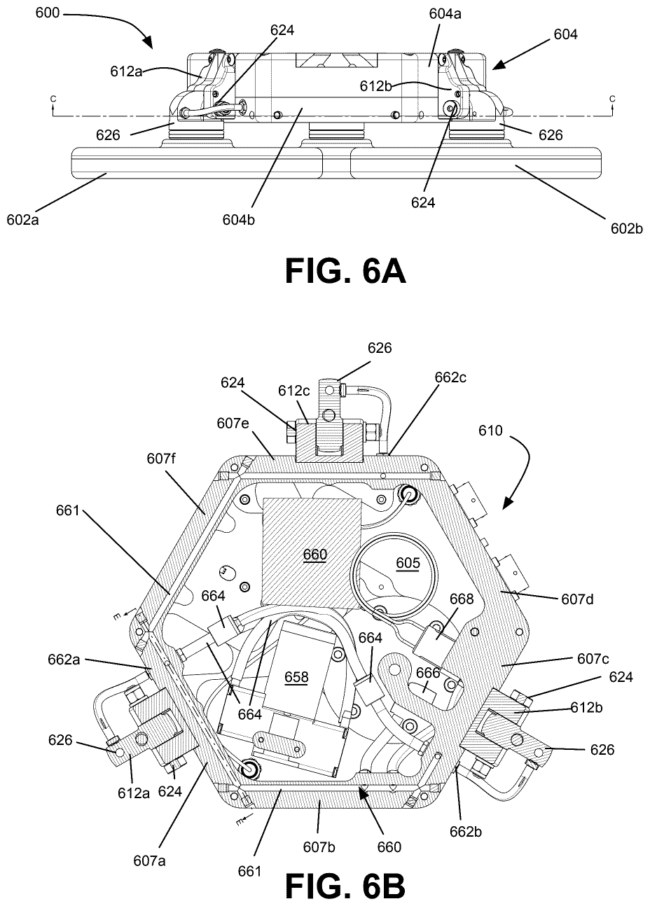

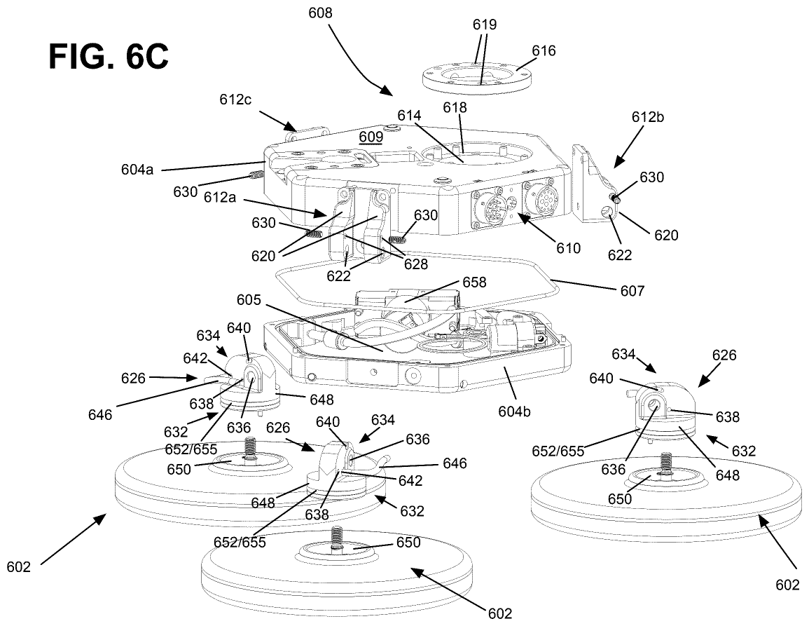

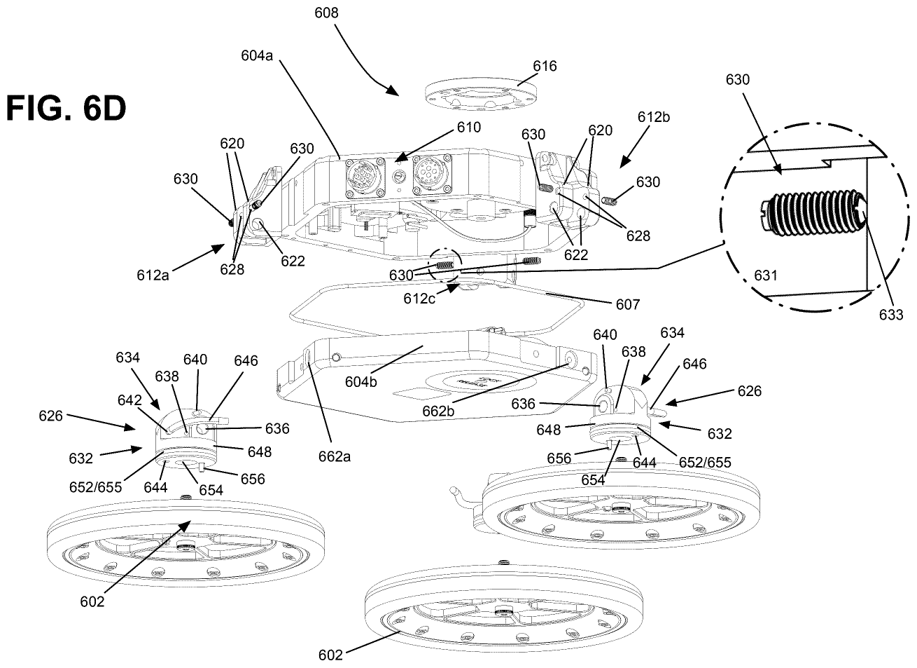

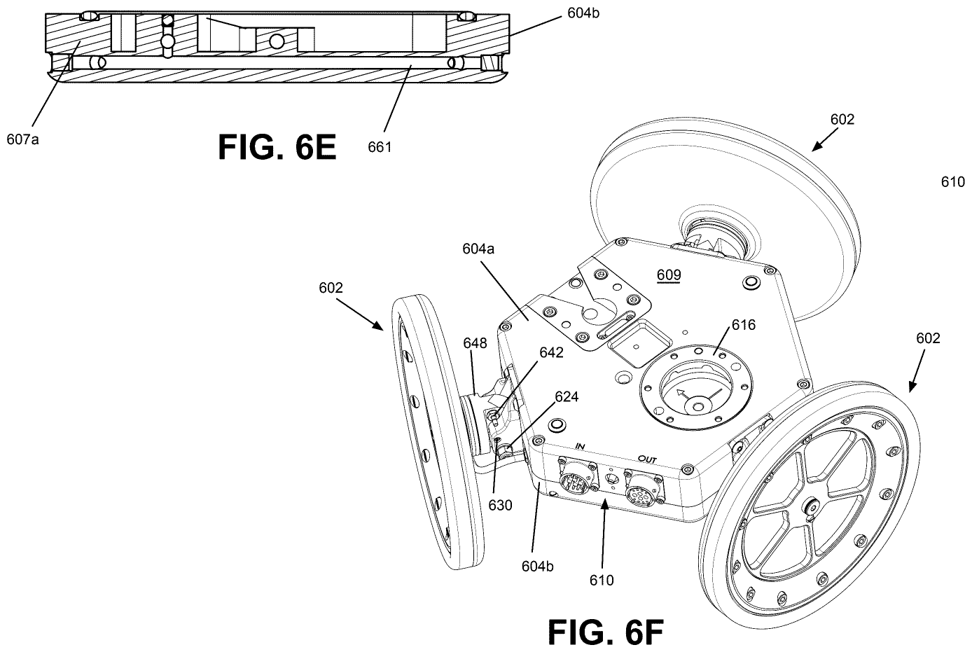

FIGS. 6A-6D are side plan, bottom cross-sectional view (along line C-C in FIG. 6A), top exploded isometric, bottom exploded isometric views, respectively, of a vacuum mount 600 coupled to a plurality of articulatable vacuum mounting feet 602a-602c (collectively referred to as vacuum mounting foot 602 and collectively referred to as vacuum mounting feet 602), consistent with a second implementation described herein. FIG. 6E is a side cross-section view taken along the line D-D in FIG. 6B. 6F is an isometric view of vacuum mount 600 depicting vacuum feet 602 in a rotated, or pre-deployment configuration.

As shown in FIGS. 6A-6E, vacuum mount 600 includes an upper housing 604a and a lower housing 604b (collectively referred to as vacuum housing 604) coupled together via any suitable mechanism, such as bolts, latches, clips, etc. to form a housing chamber 605 therein. In one implementation, a resilient seal, gasket, or O-ring 607 may be provided between upper housing 604a and lower housing 604b to ensure vacuum integrity within housing chamber 605. Consistent with implementations described herein, upper and lower housings 604a/604b include a generally hexagonal configuration having size identical side walls 607a-607f. As described below, such a configuration allows for efficient packaging of vacuum mount 600 that enables vacuum mount 600 to be inserted into a testing environment via an access port.

Upper housing 604a includes a coupling device interface assembly 608 formed in a top surface 609 thereof, a remote cabling/wiring interface 610 positioned within a side wall 607, and a plurality of mounting hinges 612a to 612c (individually referred to as mounting hinge 612 and collectively referred to as mounting hinges 612) also mounted to respective side walls 607, as further described below.

As shown in FIGS. 6C and 6D, coupling device interface assembly 608 comprises a circular cavity 614 and a lock engagement ring 616. Circular cavity 614 is formed in top surface 609 and includes a diameter and depth sufficient to accommodate receipt of connecting interface shaft 220 and locking balls 226, described above. Circular cavity 614 further includes a shoulder portion 618 for receiving lock engagement ring 616 thereon. Lock engagement ring 616 is secured to shoulder portion 618 and includes a generally ring-like configuration having an outside diameter similar to that of shoulder portion 618 and an inside diameter substantially identical to the outside diameter of shaft portion 221, yet smaller than the maximum outside diameter of locking balls 226, when actuated into the locked state, as described above. As shown, lock engagement ring 616 includes locating apertures 619 therein that correspond in position and size to locating features 229 in end effector connector assembly 202, described above, to ensure accurate positioning of coupling device 104 relative to vacuum mount 106.

Remote cabling/wiring interface 610 provides a dedicated remote control interface for each vacuum mount 607 and may include ports or receptacles for various communications/power features, such as electricity, network cabling, etc. Consistent with the implementation shown in FIGS. 6A-6F, mounting hinges 612 provide an articulatable connection point for each vacuum foot 602, as described in additional detail below. As shown, each mounting hinge 612 includes a pair of spaced apart hinge members 620 that each include aligned hinge pin apertures 622 that extend through each hinge member's widest portion and sized to receive a hinge pin 624. Spaced apart members 620 are spaced to receive foot hinge portion 626 therebetween, as shown in FIG. 6A. As described below, and as shown in FIG. 6C, spaced apart members 620 each further include deflection fixation apertures 628 for receiving rotation limiting pins 630 (FIGS. 6C and 6D) therein.

As shown in FIGS. 6C and 6D, foot hinge portions 626 each include a foot interface portion 632 and a hinge interface portion 634 projecting upwardly therefrom. Hinge interface portion 634 includes a maximum width sized for receipt between spaced apart members 620 of mounting hinges 612. Further, hinge interface portion 634 includes a hinge pin aperture 636 formed transversely therethrough and positioned to enable communication with hinge pin aperture 622 in mounting hinge 612. When assembled, each foot hinge portion 626 is pivotably coupled to a respective mounting hinge 612 by inserting hinge pin 624 into aligned apertures 622 and 636. Hinge pin 624 may be secured in any suitable manner (e.g., retaining pin, nut, friction cap, etc.).

Hinge interface portion 634 further includes foot fixation detents 638 and a deflection limiting groove 640 each configured to selectively receive a portion of rotation limiting pin 630. In one implementation, as shown in the breakout portion of FIG. 6D, each rotation limiting pin 630 includes a spring loaded retaining feature that includes a hollow threaded body 631, a spring (not shown) received within hollow threaded body 631, and a ball 633 captured within the end of hollow threaded body 631 and biased outwardly by the retained spring. During assembly, rotation limiting pins 630 are inserted (e.g., threaded) into deflection fixation apertures 628 such that the ball 633 projects inwardly therefrom.

When in pre-deployment configuration, such as that shown in FIG. 6G, rotation limiting pins 630 are rotated about hinge pin 624 so that ball 633 is abuts foot fixation detent 638 in hinge portion 626. The spring bias within rotation limiting pin 630 urges ball 633 into detent 638 thus inhibiting free movement of vacuum foot 602 about hinge pin 624 relative to vacuum housing 604.

When in an operational configuration, vacuum foot 602 may be rotated about hinge pin 624 with sufficient force to cause ball 633 to retract within threaded body 631. Continued rotation of vacuum foot 602 about hinge pin 624 may be performed until at least a portion of deflection limiting groove 640 aligns with rotation limiting pin 630 in mounting hinges 612. In this position, the spring bias within pin 630 causes ball 630 to project into deflection limiting groove 640, this limiting free movement of vacuum foot 630 in areas beyond the range of deflection limiting groove 640. As shown in FIG. 6C, deflection limiting groove 640 may have an arced configuration, such that pivoting movement of vacuum foot 602 is permitted about hinge point 624 within the range of motion established by the slot deflection limiting groove 640.

Foot hinge portion 626 further includes a vacuum pressure channel (not shown) having a first end 642 provided in hinge interface portion 634 to which a source of vacuum pressure is applied, and a second end 644 provided in foot interface portion 632 that mates with vacuum foot 602 as described below to introduce the vacuum pressure to vacuum foot 602. As shown in FIGS. 6A-6G, first end 642 of each vacuum pressure channel may be coupled to housing 604 via an air hose 646 or similar tubing to accommodate deflection in a maximum range of motion.

Foot interface portion 632 further includes a generally cylindrical portion 648 for mating with a corresponding cylindrical recess 650 within vacuum foot 602. In one implementation, cylindrical portion 648 includes an annular slot 652 for receiving a resilient O-ring or similar seal 655 for preventing a loss of vacuum pressure at the interface between vacuum foot 602 and foot interface portion 632.

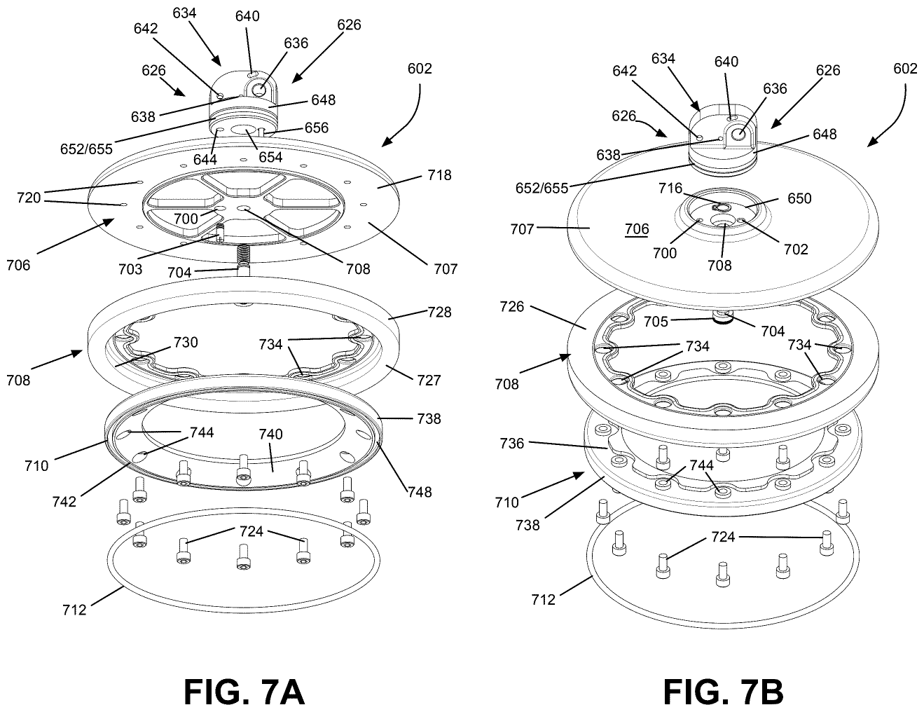

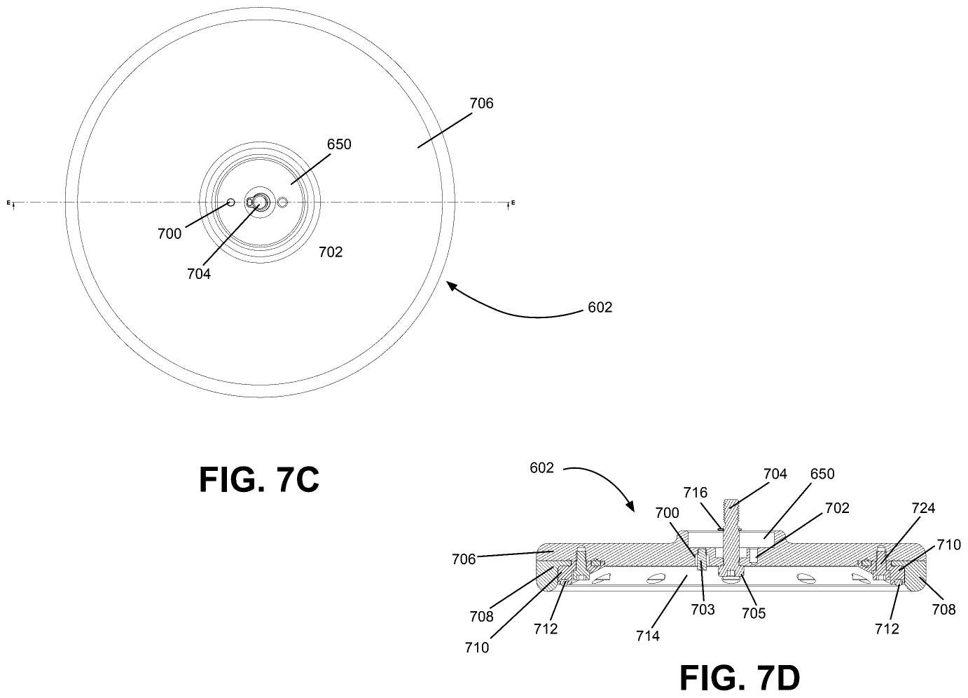

As shown in FIG. 6C, a bottom surface of cylindrical portion 648 includes second end 644 of the vacuum pressure channel, a foot securing aperture 654 and a fixation pin 656 that projects downwardly from the bottom surface of cylindrical portion 648. As described below in relation to FIGS. 7A-7D, second end 644 of the vacuum pressure channel is configured to align with a vacuum port 700 in vacuum foot 602 when fixation pin 656 engages a fixation pin aperture 702 in vacuum foot 602. Effectively, fixation pin 656/pin aperture 702 ensure that foot interface portion 632 is properly lined up with vacuum foot 602 during assembly. Foot securing aperture 654 may include a threaded configuration for receiving a foot mounting bolt 704 therein, during assembly. In one implementation, second end 644 of the vacuum pressure channel may have a threaded configuration for receiving a filter element 703 therein. For example, filter element 703 may include a sintered stainless steel filter or breather valve for preventing ingress of debris or other materials into the vacuum pressure channel.

Returning to vacuum housing 604, as shown in FIGS. 6B and 6C, vacuum housing 604 further includes a vacuum pump 658 in housing chamber 605 to provide an independent source of vacuum to vacuum feet 602. Consistent with implementations described herein, vacuum pump 658 may be coupled to a remote source of power/control via remote cabling/wiring interface 610 and an on-board microprocessor 660. Although not depicted in the figures, in some implementations, vacuum mount 600 may be provided with a second vacuum pump that operates in conjunction with vacuum pump 658 to provide failsafe performance in the event of a malfunction of vacuum pump 658.

Vacuum pump 658 may be coupled to a manifold 660 for distributing negative pressure to vacuum feet 602. In one implementation, as shown in FIGS. 6B and 6E manifold 660 is integrated as manifold channels 661 formed within mount housing 604, such as within side walls 607 in lower housing 604b. As shown, manifold channels 661 may be formed within side walls 607 and any external openings are capped off prior to assembly of vacuum housing 604. Vacuum mount housing 604 further includes vacuum ports 662a to 662c (individually referred to as a vacuum port 662 and collectively referred to as vacuum ports 662) provided proximate to each hinge 612/vacuum foot 602. Vacuum ports 660 are coupled to manifold channels 661 within side walls 607 using any suitable fitting, such as a barbed tube fitting, etc.

As shown in FIG. 6B, vacuum mount 600 further includes internal tubing 664 for coupling vacuum 658 to manifold channels 661, as well as one or more check valves 664, a pressure transducer 666, and a pressure release solenoid 668 for effecting consistent and reliable vacuum pressure and pressure release within vacuum mount housing 604.

FIGS. 7A-7D are a top exploded isometric view, a bottom exploded isometric view, a top view, and a cross-sectional view taken along the line E-E in FIG. 7C, respectively, of a vacuum foot 602 consistent with implementations described herein. Consistent with one exemplary implementation, each vacuum foot 602 comprises a foot housing 706; a compressible sealing ring 708, a support ring 710, a resilient O-ring 712, and a vacuum chamber 714.

Foot housing 706 includes a generally disc-shaped member 707 configured to receive a distal end of foot interface portion 632 of foot hinge portions 626. For example, as shown in FIGS. 7B-7D, the top of disc-shaped member 707 includes recess 650 described above for receiving cylindrical portion 648 in foot interface portion 632. Further, disc-shaped member 707 may include a central aperture 708 positioned concentrically therethrough for receiving foot mounting bolt 704. In one implementation, as shown in FIGS. 7B and 7D, foot mounting bolt 704 may include a tool engagement head 705 for facilitating securing of foot mounting bolt 704 to foot securing aperture 654 in cylindrical portion 648. In some embodiments, a clip 716 may be used to prevent foot mounting bolt 704 from being separated from aperture 708 prior to assembly. As described above, upper surface of disc-shaped member 707 further includes vacuum port 700 and fixation pin aperture 702 within recess 650 for alignment with corresponding features in foot interface portion 632. Further, as shown in FIG. 7A, disc-shaped member 707 includes a planar bottom surface 718 having a series of apertures 720 (e.g., threaded apertures) spaced radially about its perimeter for receiving a plurality of fasteners 724 (e.g., screws) therethrough during assembly, as described below.

Compressible sealing ring 708 is a generally ring-shaped component having a top side 726, a bottom side 727, an outer sidewall 730, and an inner sidewall 732. Top side 726 of compressible sealing ring 708 is substantially planar and is configured to engage planar bottom surface 718 of disc-shaped member 707. In one implementation, as shown in FIGS. 7A and 7B, a top side 726 of compressible sealing ring 708 includes a series of radially spaced apertures 734 configured to align with apertures 720 in disc-shaped member 707 for receiving fasteners 728 during assembly. In some implementations, as shown in FIG. 7D, top side 726 may include ribbed portions 738 that project outwardly from the upper and lower surfaces of top side 726 proximate to apertures 734 to assist in sealing apertures 734 from any loss in vacuum pressure. Furthermore, as shown in FIGS. 7A and 7B, an inside surface of top side 726 may include a wavy configuration for providing an alignment aid in aligning support ring 710 with compressible sealing ring 708 during assembly, as described in additional detail below.

Outer sidewall 730 of compressible sealing ring 708 projects downwardly from top side 726 and includes a diameter substantially identical to an outer diameter of disc-shaped member 707. Inner sidewall 732 also projects downwardly from top side 726 and has a diameter equivalent to an outside diameter of the support ring 710. Substantially planar annular bottom surface 727 that is formed between outer sidewall 730 and inner sidewall 732 forms the primary sealing surface for vacuum foot 702 when in use. In some implementations, compressible sealing ring 708 is formed of a cast elastomeric material having a relatively low durometer value, so as to compress and conform to the surface to which vacuum foot 702 is attached.

Support ring 710 is a generally cone-shaped ring having an upper surface 736, and outer surface 738, and inner surface 740, and a bottom surface 742. Upper surface 736 of support ring 710 is mounted to an underside of compressible sealing ring 708. As shown, in FIGS. 7A and 7B, upper surface 736 and angled inner surface 740 may include a series of radially spaced apertures 744 configured to align with apertures 720 in disc-shaped member 707 and apertures 734 in compressible sealing ring 708 for receiving fasteners 728 during assembly. Furthermore, as shown in FIGS. 7A and 7B, upper surface 736 may include a matingly wavy configuration for providing aligning with the wavy configuration of top side 726 of compressible sealing ring 708, thereby aligning apertures 744 with apertures 734.

As shown in FIG. 7A, outer surface 738 includes a generally annular surface configured to fit within inner sidewall 732 of compressible sealing ring 708. In some implementations, a height of outer surface 738 is less than a height of outer sidewall 730/inner sidewall 732, such that bottom surface 727 of compressible sealing ring 708 projects below bottom surface 742. The combined interiors of foot housing 706, sealing ring 708, and support ring 710 collectively form vacuum chamber 714 between a bottom surface of foot housing 706 and a surface of the environment in which robot 100 is placed.

As shown in FIGS. 7A and 7D, bottom surface 742 of support ring 710 may include an annular groove 748 therein for receiving resilient O-ring 712. During use, upon application of vacuum pressure within In one implementation, resilient O-ring 712 may be formed of a material having a higher durometer value that that of compressible sealing ring 708, to provide both additional sealing and a stable friction surface relative to that of compressible sealing pad 708. As shown, in one implementation, annular groove 748 may be a capture groove having an entrance with a width smaller than the diameter of O-ring 712. In this manner, during assembly, O-ring 712 may be forced into groove 748 and is retained there by the decreased entrance width.

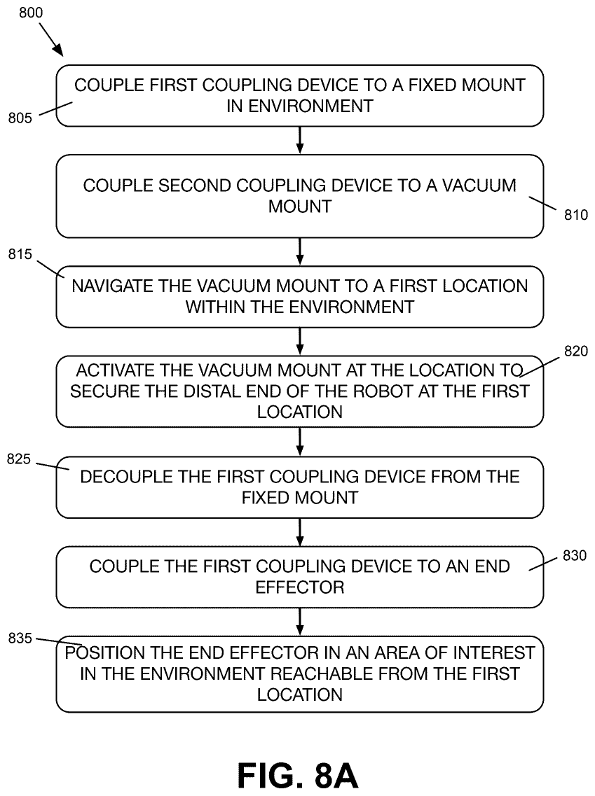

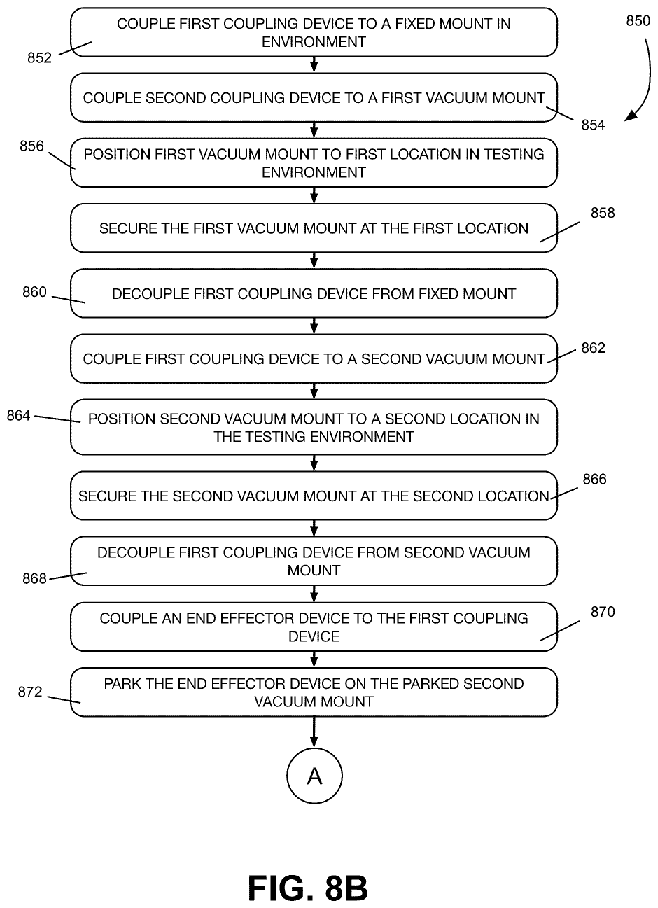

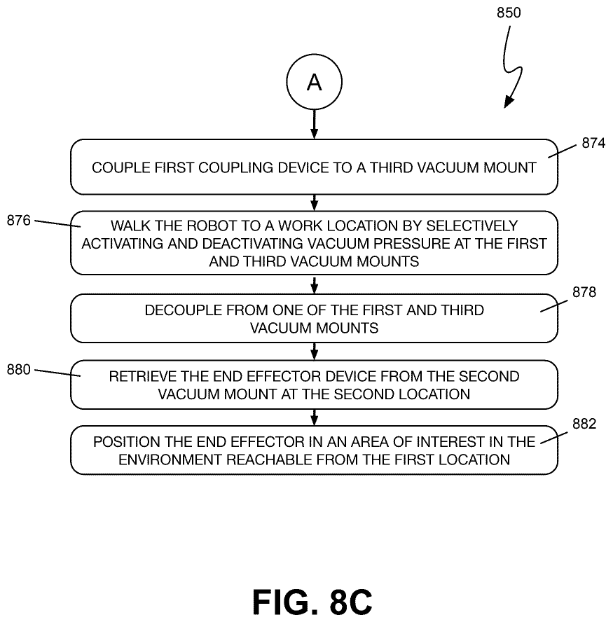

FIG. 8A is a flow diagram depicting an exemplary process 800 for implementing inspection and maintenance robot 100 within a test environment in a manner consistent with implementations described herein. Initially, when placed in use (e.g., via an access or entry port in the testing environment), a first coupling device 104 (e.g., coupling device 104b) may be coupled to a fixed (or “home”) mount located within or adjacent to the testing environment (block 805). For example, a fixed mount may be positioned at an access or entry port to a vessel under test. Such a fixed mount may include a coupling device interface similar to coupling device interface assembly 304/608 described above in relation to vacuum mount 106/600. In this manner, end effector connector assembly 202 in coupling device 104 may securely and selectively couple and decouple from the fixed mount.

The second coupling device 104 (e.g., coupling device 104a) may then couple to a vacuum mount 106/600 in the manner described above (block 810). Inspection and maintenance robot 100 may then position or navigate the second coupling device 104 to a first location within the testing environment by moving various ones of articulatable segments 108 (block 815). Given that first coupling device 104 is secured to a fixed mount, the first location is necessarily “reachable” by inspection and maintenance robot 100 from the location of the fixed mount.

The vacuum mount 106/600 is then activated to secure the distal end of inspection and maintenance robot 100 to the first location (block 820). For example, vacuum pump 328/658 in vacuum mount 106/600 may be activated via its remote cabling/wiring interface 306/610. First coupling device 104 may then be disengaged or decoupled from the fixed mount (block 825) and coupled to an appropriate end effector device, such as an inspection tool, etc. (block 830). The inspection and maintenance robot 100 may then position the end effector device in an area of interest within the testing environment that is reachable from the first location (block 835).

Consistent with the embodiment of FIG. 8A, a single vacuum mount 106/600 may be used to effectively double the service distance of inspection and maintenance robot 100 by providing a positionable mount location within the testing environment.

FIGS. 8B-8C depict a flow diagram depicting another exemplary process 850 for implementing inspection and maintenance robot 100 within a test environment in a manner consistent with implementations described herein. Similar to process 800 described above, a first coupling device 104 may be initially coupled to a fixed (or “home”) mount located within or adjacent to the testing environment (block 852).

The second coupling device 104 (e.g., coupling device 104a) may then couple to a first vacuum mount 106/600 in the manner described above (block 854). Inspection and maintenance robot 100 may then position or navigate the first vacuum mount 106/600 to a first location within the testing environment by moving various ones of articulatable segments 108 (block 856). The first vacuum mount 106/600 is then activated to secure the distal end of inspection and maintenance robot 100 to the first location (block 858). For example, vacuum pump 328/658 in vacuum mount 106/600 may be activated via its remote cabling/wiring interface 306/610. First coupling device 104 may then be disengaged or decoupled from the fixed mount (block 860) and couple to a second vacuum mount 106/600 (block 862).

Inspection and maintenance robot 100 may then position or navigate the second vacuum mount 106/600 to a second location within the testing environment by moving various ones of articulatable segments 108 (block 864). The second vacuum mount 106/600 is then activated (i.e., “parked”) to secure the second vacuum mount 106/600 to the second location (block 666/866). The first coupling device 104 may then be disengaged or decoupled from the second vacuum mount 106/600 (block 868).

Inspection and maintenance robot 100 may then return the first coupling device 104 to the home location and couple to an appropriate end effector device, such as an inspection tool, etc. (block 870). Inspection and maintenance robot 100 may then return to the second location and may park the end effector device onto the second vacuum mount 106/600 (block 872). Inspection and maintenance robot 100 may then return the first coupling device 104 to the home location and couple to a third vacuum mount 106 (block 874—FIG. 6C).

Inspection and maintenance robot 100 may move (e.g., “bipod walk”) to a work location within the testing environment (block 876). That is, inspection and maintenance robot 100 may navigate within the testing environment to the work location by selective activating and deactivating first and third vacuum mounts 106/600. Inspection and maintenance robot 100 may then park and decouple from one of the vacuum mounts 106/600 (block 878) and return and couple to the end effective device, which was parked at the second location (block 880).

If a desired testing location is within reach of inspection and maintenance robot 100, robot 100 may initiate any testing/maintenance activity using the coupled end effector device (block 882). However, if additional travel is necessary to reach the testing site, robot 100 may park the end effector device onto the parked and decoupled vacuum mount 106/600 and return to the second location to retrieve the first vacuum mount 106/600 initially parked at the block 866 above. Robot 100 may then travel further into the testing environment within reach of the re-parked end effector device. This process may repeat as many times as necessary to reach a desired testing location within the testing environment.

Although an exemplary inspection and maintenance robot 100 is described above, it should be understood that the embodiments described herein may have applicability in a variety of inspection devices or other hazardous testing environments. Further, although embodiments utilizing two or three vacuum mounts 106/600 are described, in practice any practicable number of vacuum mounts 106/600 may be used to enable efficient traversal and testing/maintenance operations with a testing environment.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments. For example, variations to the number of vacuum feet 114, the shape of the vacuum mount housing 112, the number of articulatable and interconnecting segments 108/110 in robotic arm assembly 102, etc. may be made without departing from the improvements described herein. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Similarly, relative terms, such as “upper/lower,” “front/rear,” “top/bottom,” and “forward/backward” are used to depict relative positioning with respect to described components and do not refer to absolute or gravity-based relative positions. Embodiments described herein may be implemented in any suitable orientation.

What is claimed is:

1. A vacuum mount for an inspection and maintenance robot, comprising:
a vacuum mount housing configured for releasable coupling to the inspection and maintenance robot;
at least one vacuum pump provided in the vacuum mount housing; and
at least one vacuum foot articulatably coupled to the vacuum mount housing,
wherein the at least one vacuum foot receives a source of negative pressure from the at least one vacuum pump,
wherein the vacuum mount housing includes power and communications independently from the inspection and maintenance robot so as to be capable of generating the source of negative pressure when not coupled to the inspection and maintenance robot.

2. The vacuum mount of claim 1,
wherein the at least one vacuum foot comprises three vacuum feet spaced radially about the vacuum mount.

3. The vacuum mount of claim 1, wherein each of the at least one vacuum foot is coupled to the vacuum mount housing via a hinge.

4. The vacuum mount of claim 1, wherein each of the at least one vacuum foot comprises:
a disc-shaped foot housing having a mounting bolt projecting through a top surface thereof; and
at least one sealing ring provided on a bottom surface of the disc-shaped foot housing.

5. The vacuum mount of claim 4, wherein the mounting bolt is centrally positioned on the top surface.

6. The vacuum mount of claim 5, wherein the mounting bolt couples to the vacuum mount housing via a hinge.

7. The vacuum mount of claim 4, wherein each of the at least one vacuum foot comprises:
a vacuum chamber formed within the at least one sealing ring and the disc-shaped foot housing.

8. The vacuum mount of claim 7, wherein the at least one sealing ring comprises a compressible sealing ring configured to compress when a negative pressure is formed in the vacuum chamber.

9. The vacuum mount of claim 8, wherein the at least one sealing ring further comprises a support ring, wherein the compressible sealing ring is interposed between the disc-shaped foot housing and the support ring.

10. The vacuum mount of claim 9, wherein the support ring comprises:
an outer sidewall projecting from a first surface of the support ring and configured to engage a perimeter of the compressible sealing ring; and
an inner sidewall projecting from a second surface of the support ring and configured to receive one or more fasteners to secure the compressible sealing ring to the disc-shaped foot housing.

11. The vacuum mount of claim 9, wherein the support ring comprises an annular groove on a bottom surface thereof for receiving a O-ring therein.

12. The vacuum mount of claim 11, wherein the compressible sealing ring comprises a resilient material, and wherein the support ring comprises a rigid or semi-rigid material.

13. The vacuum mount of claim 1, wherein the vacuum mount housing comprises an end effector device engagement element for enabling an end effector device to attach to the vacuum mount housing when the an end effector device is not in use by the inspection and maintenance robot.

14. An inspection and maintenance robot, comprising:
a robotic arm assembly comprising a plurality of articulatable segments,
wherein the robotic arm assembly comprises a first end and a second end;
first and second coupling devices coupled to the first end and the second end of the robotic arm assembly, respectively; and
at least two vacuum mounts selectably couplable to either of the first and second coupling devices to mount the inspection and maintenance robot within a testing environment,
wherein the at least two vacuum mounts independently interface with power and communications so as to be capable of generating a source of negative pressure when not coupled to either the first or second coupling device.

15. The inspection and maintenance robot of claim 14, wherein each of the at least two vacuum mounts comprises:
a vacuum mount housing configured for releasable coupling to the first or second coupling device;
at least one vacuum pump provided in the vacuum mount housing; and
at least one vacuum foot articulatably coupled to the vacuum mount housing,
wherein the at least one vacuum foot receives a source of negative pressure from the at least one vacuum pump.

16. The inspection and maintenance robot of claim 15,
wherein the at least one vacuum foot comprises three vacuum feet spaced radially about the vacuum mount.

17. The inspection and maintenance robot of claim 15, wherein each of the at least one vacuum foot is coupled to the vacuum mount housing via a hinge.

18. The inspection and maintenance robot of claim 15, wherein each of the at least one vacuum foot comprises:
a disc-shaped foot housing having a mounting post on a top surface; and
at least one sealing ring provided on a bottom surface of the disc-shaped foot housing.

19. The inspection and maintenance robot of claim 18, wherein the mounting post is centrally positioned on the top surface and wherein the mounting post couples to the vacuum mount housing via a hinge.

20. The inspection and maintenance robot of claim 18, wherein each of the at least one vacuum foot comprises:
a vacuum chamber formed within the at least one sealing ring and the disc-shaped foot housing.

21. The inspection and maintenance robot of claim 20, wherein the at least one sealing ring comprises a compressible sealing ring configured to compress when a negative pressure is formed in the vacuum chamber.

22. The inspection and maintenance robot of claim 21, wherein the at least one sealing ring further comprises a support ring interposed between the disc-shaped foot housing and the compressible sealing ring.

23. The inspection and maintenance robot of claim 22, wherein the support ring comprises:
an outer sidewall projecting from a first surface of the support ring and configured to engage a perimeter of the disc-shaped foot housing; and
an inner sidewall projecting from a second surface of the support ring and configured to engage an inner surface of the compressible sealing ring.

24. The inspection and maintenance robot of claim 22, wherein the at least one sealing ring further comprises a compression limiting ring configured to limit the amount of compression of the compressible sealing ring.

25. The inspection and maintenance robot of claim 24, wherein the compressible sealing ring comprises a resilient material, and wherein the compression limiting ring comprises a rigid or semi-rigid material.

26. The inspection and maintenance robot of claim of claim 15, wherein the vacuum mount housing comprises an end effector device engagement element for enabling an end effector device to attach to the vacuum mount housing when the an end effector device is not in use by the inspection and maintenance robot.

27. A method for operating an inspection and maintenance robot in a testing environment, comprising:
coupling a first end of the robot to a fixed mount in the testing environment,
coupling a second end of the robot to a vacuum mount,
wherein the vacuum mount comprises:
at least one vacuum pump provided in the vacuum mount housing; and
at least one vacuum foot articulatably coupled to the vacuum mount housing,
wherein the at least one vacuum foot receives a source of negative pressure from the at least one vacuum pump,
wherein the vacuum mount housing includes power and communications independently from the inspection and maintenance robot so as to be capable of generating the source of negative pressure when not coupled to the inspection and maintenance robot,
navigating the first end of the robot to a work location within the testing environment,
securing the vacuum mount at the work location by activating the source of negative pressure,
decoupling the first end of the robot from the fixed mount,
coupling the first end of the robot to an end effector device, and
performing inspection or maintenance operations adjacent the work location using the end effector device.

28. The method of claim 27, wherein the fixed mount is secured to an access of the testing environment.

29. The method of claim 28, wherein the testing environment comprises one of: a nuclear steam generator, a storage vessel, water tower, or a maritime vessel.

30. A method for operating an inspection and maintenance robot in a testing environment, comprising:
coupling a first end of the robot to a first vacuum mount, wherein the first vacuum mount includes an independently controllable source of negative pressure,
navigating the first end of the robot to a first location within the testing environment,
securing the first vacuum mount at the first location by activating the source of negative pressure at the first vacuum mount,
coupling a second end of the robot to a second vacuum mount, wherein the second vacuum mount includes an independently controllable source of negative pressure,
navigating the second end of the robot to a second location within the testing environment,
securing the second vacuum mount at the second location by activating the source of negative pressure at second vacuum mount, and
decoupling the second end of the robot from the second vacuum mount.

31. The method of claim 30, further comprising:
coupling the second end of the robot to an end effector device after decoupling from the second vacuum mount,
parking the end effector device onto the secured second vacuum mount at the second location,
coupling the second end of the robot to a third vacuum mount,
navigating the robot to a work location within the testing environment by selectively activating and deactivating the source of negative pressure at each of the first and third vacuum mounts.

32. The method of claim 31, further comprising:
decoupling a selected one of the first vacuum mount and third vacuum mount from its respective end of the robot,
coupling the free end of the robot to the parked end effector device at the second location, and
performing inspection or maintenance operations adjacent the work location using the end effector device.
